(19) United States
(12) Patent Application Publication
(10) Pub. No.: US 2015/0029204 A1
(43) Pub. Date: Jan. 29, 2015

(54) DYNAMIC LOCALIZED CONTRAST ENHANCEMENT METHOD FOR IMAGE AND COMPUTER READABLE MEDIUM OF THE SAME

(71) Applicant: SHAO-YANG WANG, NANTOU COUNTY (TW)

(72) Inventor: SHAO-YANG WANG, NANTOU COUNTY (TW)

(21) Appl. No.: 13/951,862

(22) Filed: Jul. 26, 2013

(51) Int. Cl. G06T 5/00

(52) U.S. Cl. CPC G06T 5/00
USPC 345/589

(57) ABSTRACT

A dynamic localized contrast enhancement method for images and computer readable medium is revealed. The method includes multiple steps. First scan each image frame dynamically by a window whose size is smaller than that of the image frame. Then receive color feature values of pixels in the window and generate a distribution histogram according to the color feature values of the pixels in the window. The distribution histogram shows a relationship between the color feature value and a corresponding count of the pixels while the count represents the amount of the pixels with the color feature value in the window. Finally, perform contrast stretching according to the distribution histogram so as to improve the contrast in the image frame significantly.

### BACKGROUND OF THE INVENTION

1. Fields of the invention

The current invention involves a dynamic localized contrast enhancement method for images, especially for a method that achieves the best contrast stretching due to color feature values of pixels of a localized image in the adjustable scanned window are distributed in a more concentrated form than a full image Therefore, the image frame has better contrast and sharpness.

2. Descriptions of Related Art

Dynamic contrast technique uses an intelligent image processing built-in system display to automatically detect the image signal and intelligently control the backlight brightness to control the image signal and increase contrast of the black and the white of the image significantly. Thus, the image clarity is improved. The clarity describes the detail quality of objects shown on a display. However, the image may flicker or glimmer when the backlight brightness is adjusted by a dynamic contrast technique. Thus, people feel uncomfortable and experience blurred vision and fatigue while viewing the images. Moreover, the lifespan of backlight modules is significantly reduced due to frequent and rapid adjustment of the backlight brightness.

Referring to Taiwanese Pat. Pub. No. 1315961-“image contrast enhancement method and device of the same”, it reveals a contrast stretching technique that expands the gray scale to the largest ranged of the display. Taking an 8-bit gray level display as an example, the image data of its 256 gray levels is usually represented by 256 different gray level values ranging from 0 to 255. The distribution range of the gray level values is broadened by an image contrast stretching technique. Thereby the image contrast is enhanced, and the image quality is improved so as to provide a dynamic contrast ratio function. However, the noise in the image signal is also amplified when a contrast stretching technique is used. Generally, the lower gray level signal is with a weaker strength, so it's easier to be affected by the noise. Thus, the image quality at the lower gray level becomes worse due to the noise amplified by contrast stretching. A further step of minimizing lower gray-scale noise is performed after contrast stretching so as to solve the problem of negative effect of the amplified noise produced by contrast stretching.

However, the contrast stretching methods available now are based on the range or the histogram of the color feature values of pixels of the full image to improve the full image contrast. The gray level values of the full image are distributed more widely so that the increment of the contrast ratio (contrast stretching) is limited. Moreover, the image contrast stretching cannot be applied to a localized image contrast enhancement. It is also unable to scan the full image dynamically by the adjustable window. Thus, the contrast between bright and dark areas is unable to be improved dramatically, and the gray scale does not have enough details. For certain fields with higher requirements of the contrast in details, such as art design, architecture design, medical images, security system, etc., not only may the image be interpreted inaccurately, but also the eyes of viewers may easily become fatigued.

### SUMMARY OF THE INVENTION

Therefore, the primary object of the current invention is to provide a dynamic localized contrast enhancement method for images in which color feature values of pixels in an image of a window are distributed in a more concentrated form because the size of the window is smaller than the whole image frame. Thus, only a small range of the color feature values is processed by contrast stretching and the contrast of the image frame is improved significantly. Therefore, this contrast between the light and dark areas creates a sharper image and the problem of restrictions on the contrast stretching caused by wider distribution of color feature values of full images can also be resolved.

In order to achieve the above objective, a dynamic localized contrast enhancement method for images of the current invention is provided. The method is applied to a display unit used for receiving an image sequence that includes a plurality of image frames. Each image frame employs a plurality of pixels with color feature values. The display unit can be a video card, display circuit or a built-in software display system-on-chip. The color feature value can be a value of gray level, color distribution, brightness distribution, etc. ranging from 0 to 1023 while the preferred range is 0-255. The dynamic localized contrast enhancement method for images of the present invention includes a plurality of steps. First, a window is used to scan an image frame dynamically and the size of the window is smaller than the image frame. Then, color feature values of pixels in the window are received. Next, a distribution histogram is generated according to the color feature values of the pixels in the window. The distribution histogram shows a relationship between the color feature value and the corresponding count of the pixels. The count represents the amount of the pixels with the color feature value in the window. Finally, an operation is performed by contrast stretching according to the histogram for adjusting contrast of the image in the window.

The size of the image frame, the size of the window, and other parameters of the window including movement, speed, scan area, conditions of dynamic contrast, intensity, rule or method can be set and adjusted by users. The optimal length of the window is smaller than half the length of the image frame as well as the width of the window. Moreover, the window is halted temporarily or can be manipulated forward or backward by the user triggering an input device. Thus, the present invention can be set and adjusted according to users' needs. Therefore, users' requirements for adjustment and operation can be satisfied in certain fields with higher contrast requirements in details such as art design, architecture design, medical images, security system, etc.

In addition, the dynamic localized contrast enhancement method for images is executed by a computer readable medium of a computer executable module which includes at least one computer executable instruction run by a computer.

### BRIEF DESCRIPTION OF THE DRAWINGS

The structure and the technical means adopted by the current invention to achieve the above and other objects can be best understood by referring to the following detailed description of the preferred embodiments and the accompanying drawings, wherein

FIG. 1 is a flow chart showing steps of an embodiment according to the present invention;

FIG. 2 is a schematic drawing showing movement of a window in an image frame of an embodiment according to the present invention;

FIG. 3 is a schematic drawing showing an image frame without being scanned by a window of an embodiment according to the present invention;

FIG. 4 is a schematic drawing showing an image frame being scanned by a window at some instant of an embodiment according to the present invention.

### DETAILED DESCRIPTION OF THE PREFERRED EMBODIMENT

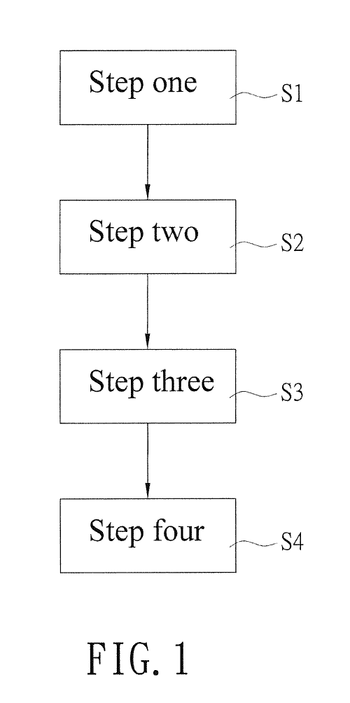

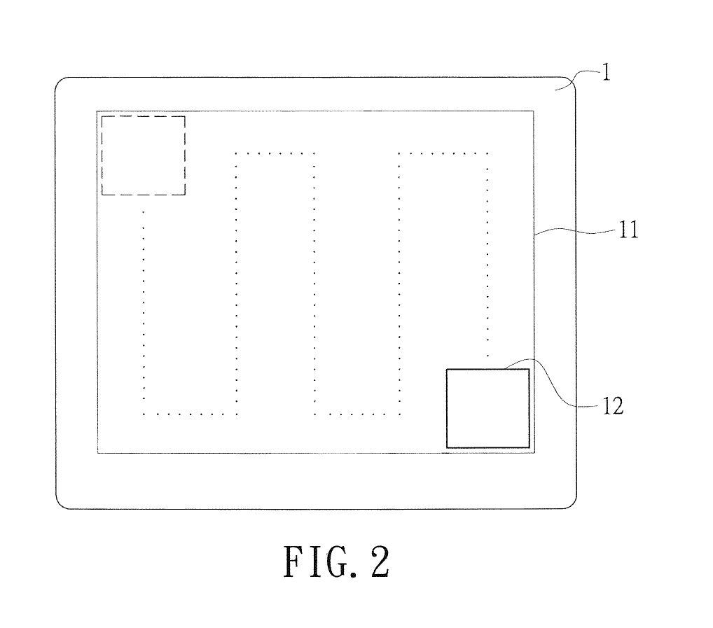

Referring to FIGS. 1-2, a method of the current invention is applied to a display unit 1. The display unit 1 can be a video card, display circuit or software built in display system-on-chip. The display unit 1 is used to receive an image sequence that includes a plurality of image frames 11. Each image frame 11 is formed by a plurality of pixels with color feature values. Generally, the color feature value (such as gray level, color distribution, brightness distribution, etc.) ranges from 0 to 1023 while the preferred range is 0-255. The range and technique of the color feature value are well known to people who are skilled in the art. Thus, there is no limit on the range and technique regarding the color feature value. Other common or new range of the color feature value can also be applied to the method of the present invention. A dynamic localized contrast enhancement method for images of the present invention includes the following steps:

Step one (S1): Using a window 12 to scan an image frame 11 dynamically. The size of the window 12 is smaller than that of the image frame 11. The preferred length of the window 12 is smaller than half the length of the image frame 11 and the width of the window 12 is also smaller than half the width of the image frame 11. For example, the resolution of the window 12 is smaller than 512×384 pixels if the resolution of the image frame 11 is 1024×768 pixels. Also refer to FIG. 2, a schematic drawing showing movement of a window in an image frame is revealed.

Step two (S2): Receiving color feature values of the pixels in the window 12;

Step three (S3): Generating a distribution histogram according to data of the pixels in the window 12. The distribution histogram shows a relationship between the color feature value and a corresponding count of the pixels. The count represents the amount of the pixels with the color feature value in the window 12. The bin width of the histogram can be a fixed value or alternatively, not fixed, so that the bins of the histogram can be formed with different widths.

Step four (S4): Performing an operation by using a contrast stretching technique according to the histogram for adjusting contrast of the image in the window 12.

The parameters of the above window 12, such as size, movement, speed, scan area over the image frame 11 conditions of dynamic contrast, intensity, rule, or method can be set and adjusted by users. As shown in FIG. 2, the window 12 scans the image frame 11 from top to bottom and from left to right. After contacting the edge of the image frame 11, the window 12 moves in the opposite direction. The dotted line represents the automatic scan path of the window 12. The scanning method of the window 12 is not limited. The window 12 can also scan the image frame, 11 from top to bottom, from right to left, or when moving randomly or regularly. Moreover, the window 12 can be halted temporarily by the user with an input device. The input device can be a keyboard, a mouse, a touch panel, a touch screen, a remote controller, a joystick, etc. For example, the window 12 is halted temporarily or can move forward or backward by pressing a keyboard button, or clicking a mouse. Furthermore, the length and the width of the image frame 11 scanned by the window 12 can be adjusted manually so that users can scan a part of the image frame 11 required by the window 12.

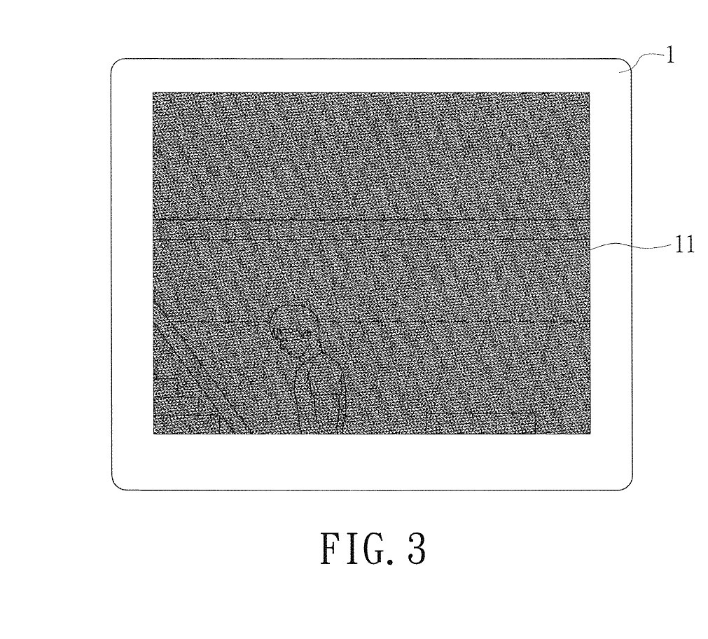

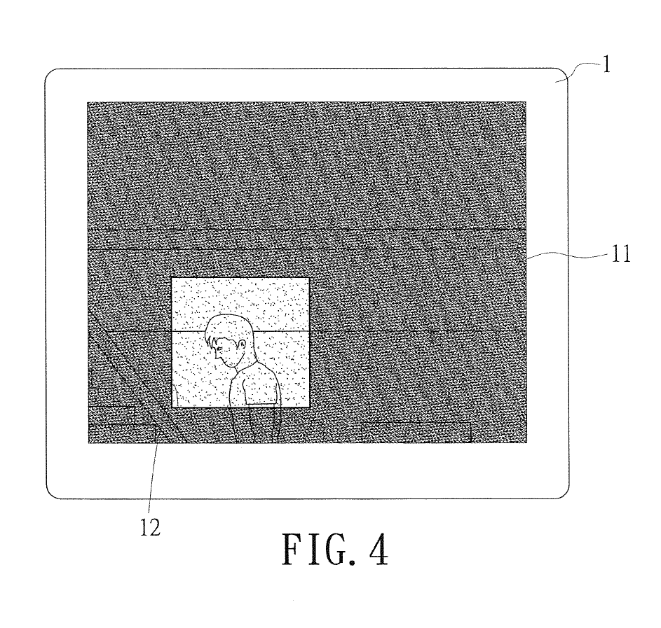

In summary, the current invention is executed on a personal computer. Referring to FIG. 3 and FIG. 4, in this embodiment, the color feature value uses gray level as an example, but is not limited to this. The color feature value can also be color distribution or brightness distribution. When the display unit 1 receives an image sequence, the image sequence may include 60 image frames 11 (the frame rate is 60 Hz). The frame rate is not limited to 60 Hz, it may be more or less than 60 Hz. When the method is applied to the display unit 1 the user first inputs the range of the image frame 11 to be scanned, and the parameters of the window 12 such as the size, movement direction and movement speed of the window 12 by the input interface (device). Then the image frame 11 is scanned by the window 12 dynamically according to the parameters set above. Now a relationship between the gray level and the count of the corresponding pixels in the window 12 is calculated in real-time manner. Next, the method is using contrast stretching to adjust the contrast of the images in the window 12. Due to the adjustable size of the window 12 and the continuity of the images, the distribution of the gray level of the pixels in the image of the window 12 is more concentrated. Thus, the restriction on the image contrast stretching caused by a wider distribution of the gray level of the full image is overcome. For example, as shown in FIG. 3, it is assumed that most of the gray level of the pixels in the image of the window is distributed around low-brightness range (such as the gray level value ranging from 10 to 50). Thus, the image contrast stretching technique is only applied to the range of the gray level value ranging from 10 to 50 and the contrast of the image frame 11 is significantly improved. Therefore, the contrast between light and dark areas of the image in the window 12 is enhanced and the accuracy of the image interpretation is improved, as shown in FIG. 4.

Furthermore, the method of the current invention can be applied to both static images and dynamic images (such as video communication). It can also be applied to various types of imaging devices such as digital cameras, electronics integrated with digital cameras, security or video monitoring system, medical imaging system, etc.

In addition, the dynamic localized contrast enhancement method for images is executed by a computer readable medium of a computer executable module which includes at least one computer executable instruction run by a computer.

Additional advantages and modifications will become readily apparent to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A dynamic localized contrast enhancement method for images applied to a display unit which is receiving a plurality of image frames that are formed by a plurality of pixels with color feature values comprising the following steps:
step one: scanning the image frame dynamically by a window whose size is smaller than that of the image frame;
step two: receiving color feature values of pixels in the window;
step three: generating a distribution histogram according to the color feature values of the pixels in the window; the distribution histogram shows a relationship between the color feature value and a corresponding count of the pixels while the count represents the amount of the pixels with the color feature value in the window;
step four: performing an operation by contrast stretching according to the distribution histogram so as to adjust image contrast in the window.

2. The method as claimed in claim 1, wherein the display is selected from the group consisting of a video card, display circuit or software built in display system-on-chip.

3. The method as claimed in claim 1, wherein the size of the window is manually adjustable.

4. The method as claimed in claim 1, wherein parameters of the window including movement, speed, scan area, conditions of dynamic contrast, intensity, rule or method is manually adjustable.

5. The method as claimed in claim 1, wherein the window is paused, manipulated forward, manipulated backward, or moved by the user triggering an input device.

6. The method as claimed in claim 1, wherein the image frame scanned by the window is manually adjustable.

7. The method as claimed in claim 1, wherein the color feature value of the pixel is ranging from 0 to 1023.

8. The method as claimed in claim 1, wherein the color feature value is selected from the group consisting of gray level value, color distribution, and brightness distribution.

9. The method as claimed in claim 1, wherein a length of the window is smaller than a half of a length of the image frame while a width of the window is smaller than a half of a width of the image frame.

10. The method as claimed in claim 1, wherein the dynamic localized contrast enhancement method for images is executed by a computer readable medium of a computer executable module and the computer executable module includes at least one computer executable instruction run by a computer.
